(19) United States
(12) Patent Application Publication
(10) Pub. No.: US 2006/0228691 A1
(43) Pub. Date: Oct. 12, 2006

(54) Search method for discovery of individual best study period cycle

(76) Inventor: Yao-Ting Chen, Taipei (TW)

Correspondence Address: LEONG C LEI, PMB # 1008, 1867 YGNACIO VALLEY ROAD, WALNUT CREEK, CA, 94598, US

(21) Appl. No.: 11/400,266

(22) Filed: Apr. 10, 2006

(30) Foreign Application Priority Data
Apr. 11, 2005 (CN) 2005100167000

(51) Int. Cl. G09B 19/00; G09B 7/00

(52) U.S. Cl. 434/362; 434/236

(57) ABSTRACT

A method is provided herein that can adaptively determine the optional review cycle for different people and for different subjects. The method models the material as a number of learning focuses and the process of material's shifting from short-term to long-term memory as transition through a series of memorization states. Then, for each memorization state, the method performs reviews by evaluating the learning focuses and gathers relevant statistics about the evaluation result to dynamically determine whether the material has now in a next memorization state or when to conduct the next review on what learning focuses.

### BACKGROUND OF THE INVENTION

(a) Technical Field of the Invention

The present invention generally relates to learning methods, and more particularly to a method of conducting reviews with optimal periodic cycle so as to retain the learned material in the long-term memory.

(b) Description of the Prior Art

In 1880, the German psychologist Ebbinghaus had conducted experiments about how well people can retain in memory material that is meaningless to them. An exemplary result is shown in FIG. 1 and the following table. As illustrated, the retained material gradually decreases with time.

| | | Retained material in | Forgotten material in |
|---|---|---|---|
| Elapsed time | | percentage | percentage |
| 20 | min. | 58 | 42 |
| 1 | hr | 44 | 56 |
| 9 | hrs. | 36 | 64 |
| 1 | day | 34 | 66 |
| 2 | days | 28 | 72 |
| 6 | days | 25 | 75 |
| 31 | days | 21 | 79 |

In 1939, the American psychologist H. F. Spitzer conducted similar experiments, but focused on material that is meaningful to the testees. An exemplary result is shown in FIG. 2 and the following table. As illustrated, people are much better retaining material that is meaningful to them.

| | | Retained material in | Forgotten material in |
|---|---|---|---|
| Elapsed time | | percentage | percentage |
| 1 | day | 54 | 46 |
| 7 | days | 35 | 65 |
| 14 | days | 21 | 79 |
| 21 | days | 19 | 81 |
| 28 | days | 18 | 82 |
| 63 | days | 17 | 83 |

Based on the foregoing experiments, psychologists have discovered a number of guidelines about learning and memorization: (1) whenever the learning stops, people start to forget; (2) some material can be retained only for minutes while some other material can be memorized for days or months; (3) review can make the material retained longer; (4) review is most effective when the curves in FIGS. 1 and 2 abruptly drops (i.e., a large amount of material is about to be forgotten); and (5) memory can be enhanced by periodic reviews so that material in the short term memory is moved to the long-term memory, as shown in FIG. 3.

The differentiation of people's memory into short-term memory and long-term memory was proposed by the American psychologist James. In the past several decades, biological study has already discovered that short-term memory relies on the existing linking structure of brain cells while long-term memory requires the formation of new links between brain cells and therefore is more stable than short-term memory. Basically, periodic reviews stimulate the formation of the new links so that material originally stored in the short-term memory is gradually “shifted” to the long-term memory.

Most existing methods about enhancing people's memory adopt the theories of Ebbinghaus and H. F. Spitzer that the best timing for review is when a large amount of material is about to be forgotten, and relies on some fixed cycle in conducting reviews.

These techniques have a number of disadvantages. First, the fixed cycle time is usually obtained through experiments conducted in laboratories. However, no two people have identical brain structures. The fixed cycle may be too short for someone yet too long for another. If the cycle time is too short, even though the intensive review indeed makes the material retained in the long-term memory, this is obvious not efficient. On the other hand, if the cycle time is too long, the material is already lost and the review is simply to learn the same material again, contributing nothing to the shifting of material into the long-term memory.

Secondly, depending on the subject of learning, the brain consumes the material differently. For example, material related to physics requires more reasoning while material related to English grammar or vocabulary requires more memorization. For different subjects, the times when a large amount of material is about to be forgotten are definitely different. The prior techniques do not use different cycles for different subjects or for different people. Nor do they adapt the review cycle dynamically according to the learning progress. On the other hand, in addition to the timing of reviews, efficient and effective reviews also involve the material to be reviewed. It is nature that a learner would develop different familiarity for different parts of the material. This is because the learners's prior knowledge and experience would give the linking of brain cells different strength for different parts of the material. The prior techniques do not provide management or suggestion to the material. For example, when only a part of the material or the entire material is not familiar, these techniques do not process these conditions discriminately; the reviews are still conducted suing the identical cycle. A good learning method should differentiate and identify the memorization states of different parts of the material so that more intensive reviews are given to those parts of the material having weaker links.

### SUMMARY OF THE INVENTION

The primary purpose of the present invention is to provided herein that can adaptively determine the optimal review cycle for different people and for different subjects. With the optimal review cycle, a learner can quickly shift the material from short-term memory to long-term memory so as to achieve efficient and effective learning.

The method models the material as a number of learning focuses and the process of material's shifting from short-term to long-term memory as transition through a series of memorization states. Then, for each memorization state, the method performs reviews by evaluating the learning focuses and gathers relevant statistics about the evaluation result to dynamically determine whether the material has now in a next memorization state or when to conduct the next review on what learning focuses.

The advantages of the present invention are as follows. First, the method conforms to the characteristics of human brain's operation. Secondly, the method is capable of being “personalized” to adapt to a specific learner. Thirdly, the method is also capable of being adapted for the learning of a specific subject. In addition, the method can achieve a balance between learning efficiency and effect through gathering statistics and dynamic adjustment.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is the Ebbinghaus forgetting curve for meaningless material.

FIG. 2 is the Spitzer forgetting curve for meaningful material.

FIG. 3 is a schematic diagram showing how periodic reviews can help retaining material in the memory.

FIG. 4 is a flow diagram showing the basic flow of the present invention

FIG. 5 is a schematic diagram showing a first embodiment of the present invention.

FIG. 6 is a schematic diagram showing a second embodiment of the present invention.

FIG. 7 is a schematic diagram showing a third embodiment of the present invention.

FIG. 8 is a schematic diagram showing an application of the present invention on a networked server.

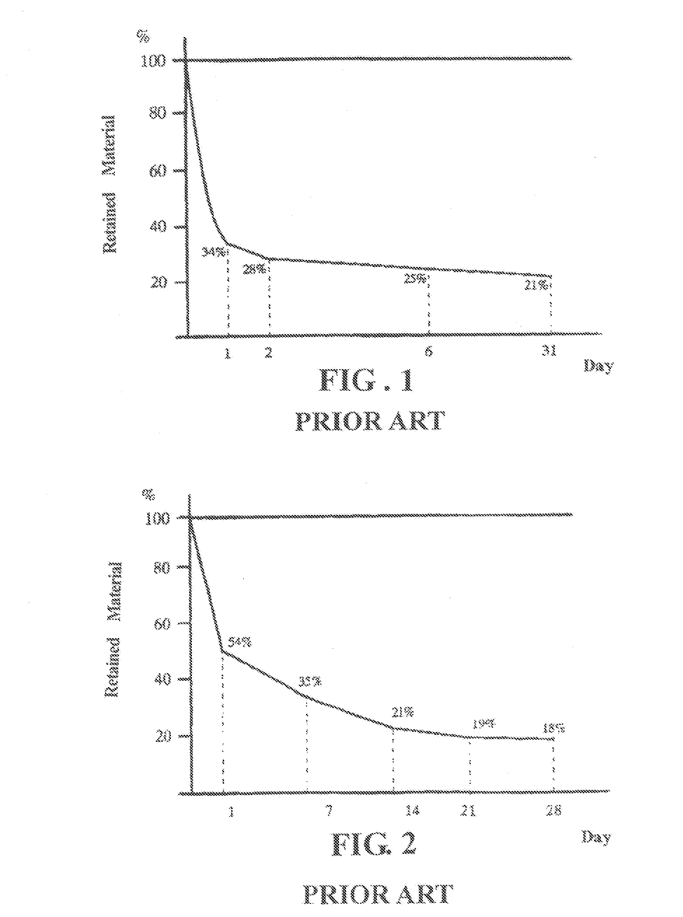

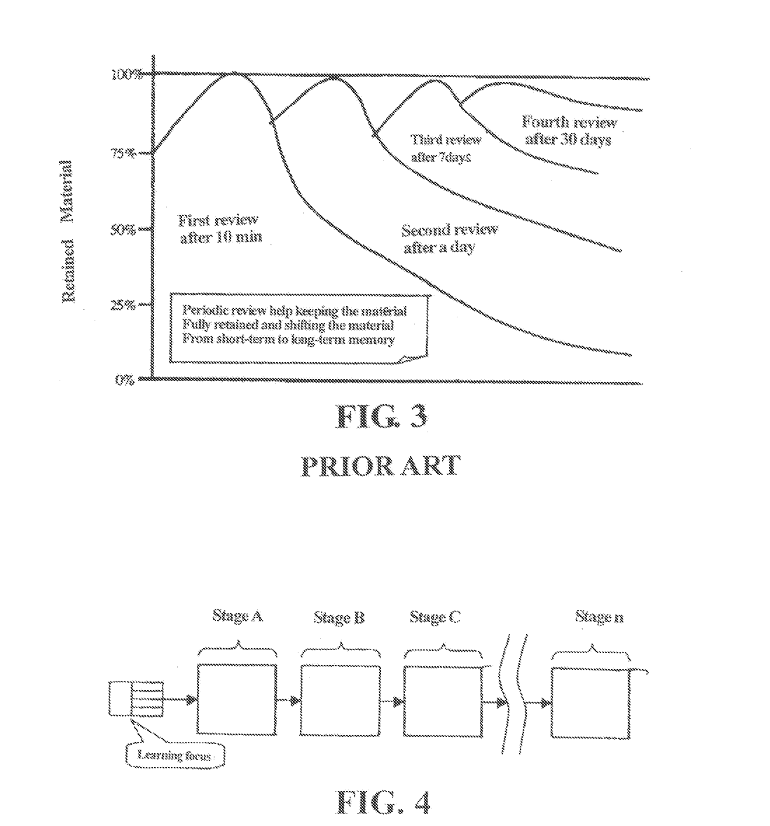

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

To facilitate the following description, a number of definitions are given as follows:

| | |
|---|---|
| Learning program | Meaning a set of associated material designed for |
| | learning in a specific period of time. It is similar to |
| | what is usually referred to as a course or unit in |
| | ordinary teaching material. |
| Learning focus | Meaning the minimum unit of material for |
| | memorization or review. A learning focus is |
| | associated with one or more questions. The question |
| | can be of various styles such as multiple-choice |
| | question, fill-in-the-blank, or question-and answer. |
| | When a learner has mastered the learning focus, the |
| | learner should be able to answer the related |
| | question(s) correctly. Therefore, when a learner is |
| | conducting a review, the question(s) can be used to |
| | evaluate whether the learner has mastered and |
| | remembered the learning focus. A learning program |
| | contains multiple learning focuses. For example, an |
| | English learning program may contain a number of |
| | words, phrases, and grammatical rules as learning |
| | focuses for memorization and review. |
| Memorization | Meaning a memorized item's current stage of |
| state | transition from short-term memory to long-term |
| | memory. By recording and analyzing the |
| | memorization sate, the present invention is able to |
| | determine the optimal review cycle for a learner. The |
| | memorization state is denoted as X which can be one |
| | of a sequence of symbols, each denoting a stage of |
| | transition. For example, X = {A, B, C, . . . } |

FIG. 4 is a flow diagram showing the basic flow of the present invention. In a preparation stage of the flow, a learner starts a new learning program, and the learner obtains and learns the learning focuses of the learning program, which are prepared by the learner himself/herself, or by a third party such a teacher or an instructor. The preparation of a learning focus is mainly about designing one or more questions to evaluate the learner by himself/herself or by a third party to determine whether the learner has mastered the learning focus.

Subsequently, the flow enters the stage A. Within the stage A, the learner conducts a review after a period of time (i.e., the waiting time). If the review is successful, the flow continues to the next stage B. Then, within the stage B, the learner conducts another review after another waiting time. If the review is successful, the flow continues to the next stage C. The process continues as described through various stages until the learner's memorization of the learning focuses has shifted from short-term memory into long-term memory.

In the foregoing basic flow, there are two important questions which are the focuses of the present invention. The first question is about how to determine the waiting time for each stage so that the learning focuses are reviewed while they remain in the short-term memory and before it is about to be forgotten. The second question is about how many stages a learner has to step through in order to transfer the learning focuses from short-term memory into long-term memory.

As mentioned earlier, each person has his/her specific learning and memorization capabilities. Therefore, the waiting time of each stage shouldn't be a fixed value, but should be adapted by an appropriate method to approach to the learner's specific characteristics. According to the experiments of the Ebbinghaus and H. F. Spitzer, an initial value could be chosen for the waiting time and then, by the method of the present invention, the waiting time is adjusted based on the learner's learning conditions. How the waiting time is adjusted will be described in the following description. Similarly, the current researchers have not specifically identified how long the periodic review needs in order to shift something from the short-term to long-term memories, but only say it would take several years. The question about the stages required to transfer the learning focuses from short-term memory into long-term memory will be given in the following description as well.

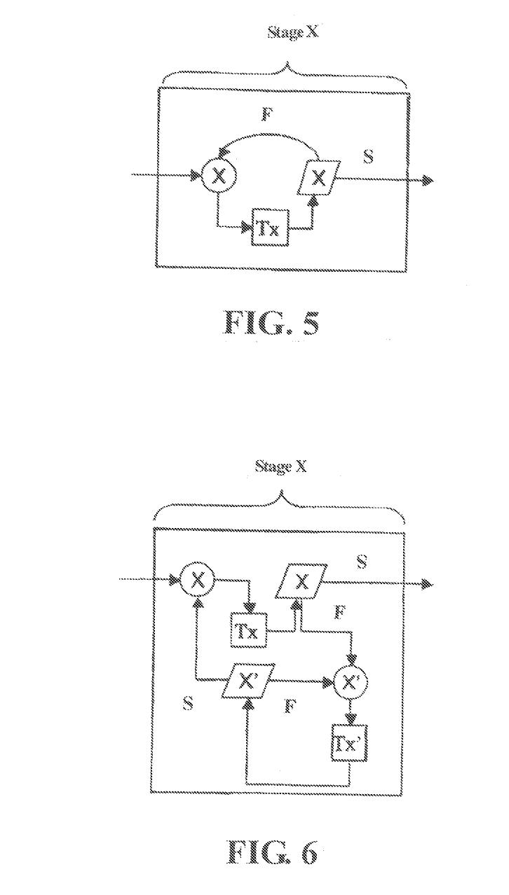

To determine the waiting time (i.e., the period of the review cycle) for a stage X of the flow of FIG. 4, FIG. 5 is a schematic diagram showing a first embodiment of the present invention. The notations used in FIG. 5 are as follows:

| Notation | Description |
|---|---|
| [symbol] | The memorization state of a learning focus when the |
| | learner enters the stage X. |
| [symbol] | The waiting time of die stage X |
| [symbol] | The review conducted in stage X |

As illustrated, within stage X, the memorization state of a learning focus is [symbol] and a review [symbol] is conducted after the waiting time [symbol] During the review, the questions associated with the learning focus are used for evaluation. If the result of evaluation for all learning focuses is “success ” (S), the flow continues to the next stage; if the result for all learning focuses is “failure” (F), the memorization state remains unchanged and another review [symbol] is conducted after the waiting time [symbol] With this process, a learner obtains periodic reviews in a stage so as to help moving the learning focuses from short-term memory into long-term memory.

The waiting time [symbol] for each stage is not fixed, but is dynamically adjusted based on the statistics about success and failure. A number of notations are described as follows.

| Notation | Description |
|---|---|
| Sx | The count of successful evaluations for all learning |
| | focuses in stage X. When a learning focus is evaluated and |
| | the result is success, the count is incremented by one. |
| Fx | The count of failed evaluations for all learning focuses in |
| | stage X. When a learning focus is evaluated and the result |
| | is failure, the count is incremented by one. |
| Sx % | The success rate, i.e. Sx % = Sx/(Sx + Fx) × 100% |
| Hx % | The upper bound of success rate which is a constant for |
| | comparison to Sx % |
| Lx % | The lower bound of success rate which is a constant for |
| | comparison to Sx % |

Within a stage X, when Sx+FX=n, the success rate of Sx% is compared to the upper and lower bounds Hx% and Lx%. If Sx%≦Lx%, this implies that the waiting time is too long so that the material is not appropriately retained even in the short-term memory. The waiting time is therefore shortened appropriately. If Lx%<Sx%<Hx%, this implies that the success rate is normal and the waiting time is not updated. if Hx%≦Sx%, this implies that the waiting time is too short and is appropriately extended without sacrificing the learning effect. After the success rate comparison, regardless of whether the waiting time is adjusted, Sx and Fx are reset to zero and the statistics are gathered all over again.

The foregoing n, Hx%, Lx% are all constants. Such as n−100, Hx%=95%, and Lx%=85%. These parameters can be configured by a learner himself or herself based on his or her specific learning goal or condition, or they can be configured by a third party. Through the aforementioned waiting time adjustment, a learner can obtain a waiting time ideal for the brain characteristics of the specific learner.

FIG. 6 is a schematic diagram showing a second embodiment of the present invention. The notations used in FIG. 6 are as follows:

| Notation | Description |
|---|---|
| [symbol] | The memorization state of a learning focus when the |
| | learner enters the stage X. |
| [symbol] | The waiting time of the stage X |
| [symbol] | The review conducted in stage X |
| [symbol] | The memorization state of a learning focus after the |
| | learner fails the evaluation. |
| [symbol] | The waiting time for another review under the |
| | memorization state [symbol] |
| [symbol] | The review conducted under the memorization state |
| | [symbol] |

As illustrated, within stage X, the memorization state of the learning focus is [symbol] and a review [symbol] is conducted after the waiting time [symbol] During the review, the questions associated with the learning focus are used for evaluation. If the result of evaluation of all learning focuses is “success” (S), the flow continues to the next stage; if the result of all learning focuses is “failure” (F), the memorization state becomes [symbol] and another review [symbol] is conducted after the waiting time

[symbol]

While under the memorization state [symbol] if the review [symbol] is success, the memorization state is returned to the state [symbol] and the review [symbol] is conducted after the waiting time [symbol] If the review [symbol] is failure, the memorization state remains [symbol] and another review [symbol] is conducted after the waiting time

[symbol]

Again, the statistics about success and failure are maintained. A number of notations are described as follows.

| Notation | Description |
|---|---|
| Sx | The count of successful evaluations for all learning |
| | focuses in stage X. When a learning focus is evaluated and |
| | the result is success, the count is incremented by one. |
| Fx | The count of failed evaluations for all learning focuses in |
| | stage X. When a learning focus is evaluated and the result |
| | is failure, the count is incremented by one. |
| Sx % | The success rate, i.e. Sx % = Sx/(Sx + Fx) × 100% |
| Hx % | The upper bound of success rate which is a constant for |
| | comparison to Sx % |
| Lx % | The lower bound of success rate which is a constant for |
| | comparison to Sx % |

Within a stage X, when Sx+Fx=n, the success rate Sx% is compared to the upper and lower bounds Hx% and Lx%. If Sx%≦Lx%, this implies that the waiting time is too long so that the learning focus is not appropriately retained even in the short-term memory. The waiting time is therefore shortened. If Lx%<Sx%<Hx%, this implies that the success rate is normal and the waiting time is unchanged. If Hx%≦Sx%, this implies that the waiting time is too short and is appropriately extended without sacrificing the learning effect. After the success rate comparison, regardless of whether the waiting time is adjusted, Sx and Fx are reset to zero and the statistics are gathered all over again. Through the aforementioned waiting time adjustment, a learner can obtain a waiting time ideal for the brain characteristics of the specific learner.

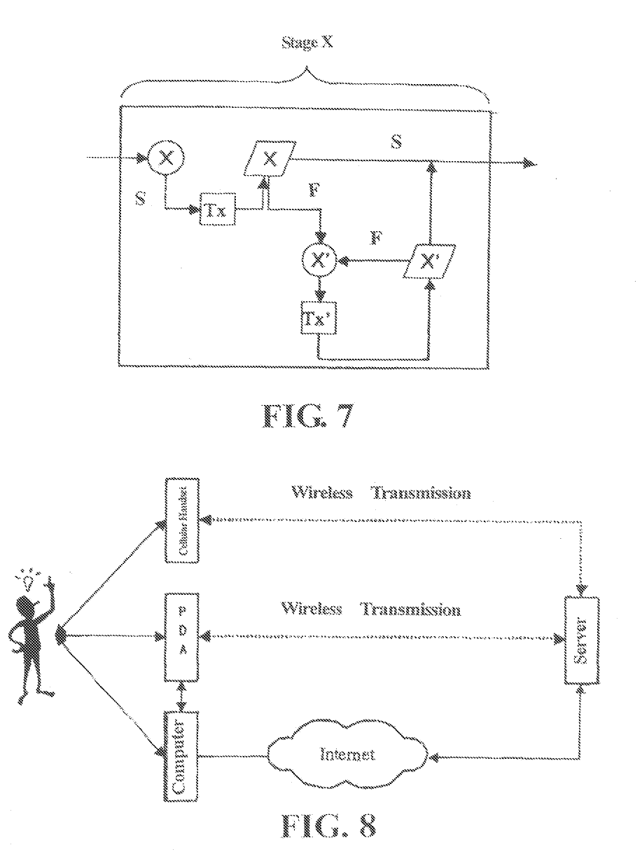

FIG. 7 is a schematic diagram showing a third embodiment of the present invention. The notations used in FIG. 7 are as follows:

| Notation | Description |
|---|---|
| [symbol] | The memorization state of a learning focus when the |
| | learner enters the stage X. |
| [symbol] | The waiting time of the stage X |
| [symbol] | The review conducted in stage X |
| [symbol] | The memorization state of a learning focus after the |
| | learner fails the evaluation. |
| [symbol] | The waiting time for another review under the |
| | memorization state [symbol] |
| [symbol] | The review conducted under the memorization state |
| | [symbol] |

As illustrated, within stage X, the memorization state of the learning focus is [symbol] and a review [symbol] is conducted after the waiting time [symbol] During the review, the questions associated with the learning focus are used for evaluation. If the result of evaluation of all learning focuses is “success” (S), the flow continues to the next stage; if the result of all learning focuses is “failure” (F), the memorization state becomes [symbol] and another review [symbol] is conducted after the waiting time

[symbol]

While under the memorization state [symbol] if the review [symbol] is success, the flow continues to the next stage. Ff the review [symbol] is failure, the memorization state remains [symbol] and another review [symbol] is conducted after the waiting time

[symbol]

Again, the statistics about success and failure are maintained. A number of notations are described as follows.

| Notation | Description |
|---|---|
| Sx | The count of successful evaluations for all learning |
| | focuses in stage X. When a learning focus is evaluated and |
| | the result is success, the count is incremented by one. |
| Fx | The count of failed evaluations for all learning focuses in |
| | stage X. When a learning focus is evaluated and the result |
| | is failure, the count is incremented by one. |
| Sx % | The success rate, i.e. Sx % = Sx/(Sx + Fx) × 100% |
| Hx % | The upper bound of success rate which is a constant for |
| | comparison to Sx % |
| Lx % | The lower bound of success rate which is a constant for |
| | comparison to Sx % |

Within a stage X, when Sx+Fx=n, the success rate Sx% is compared to the upper and lower bounds Hx% and Lx%. If Sx%≦Lx%, this implies that the waiting time is too long so that the learning focus is not appropriately retained even in the short-term memory. The waiting time is therefore shortened. If Lx%<Sx%<Hx%, this implies that the success rate is normal and the waiting time is unchanged. If Hx%≦Sx%, this implies that the waiting time is too short and is appropriately extended without sacrificing the learning effect. After the success rate comparison, regardless of whether the waiting time is adjusted, Sx and Fx are reset to zero and the statistics are gathered all over again. Through the aforementioned waiting time adjustment, a learner can obtain a stage's waiting time ideal for the brain characteristics of the specific learner.

From the above description, the present invention dynamically adjusts the period of review cycle. This dynamic adjustment also indirectly resolve the other question, which is about how many stages a learner has to follow to ensure the learning focuses are shifted into the long-term memory.

Assuming that the learning focuses are the long-term memory after stage n, this implies that most, if not all, evaluations in the stage (n+1) should be success and the success rate Sn+1% should be higher than the upper bound Hn+1%. According to the foregoing embodiment, the waiting time will be extended longer and longer. Eventually, the waiting time is so long that almost no review is required. This effectively determines the number of reviews.

The method can be applied in various learning environments. A number of examples are described as follows. The most straightforward way of application of the method is the manual track of the learning progress based on the various embodiment of the present invention. The method can be embodied as a number of printed, loosed-leaf tables and forms for recording. In an alternative scenario, the method can be implemented in a software program executing on a computer. The learning program and learning focuses are all maintained on the computer as well. The software program allows a learner to conduct reviews on the computer and keeps track of the learning condition automatically for the learner. The software program then, based on the various embodiment of the present invention, automatically alarms the learner after the calculated waiting time to conduct reviews.

The method can also be implemented as part of the function of an electronic dictionary. When a user finds a new word, he or she can device to mark the word as a learning focus for memorization. The method then allows a learner to conduct reviews on the electronic dictionary and keeps track of the learning condition automatically for the learner. The software program then, based on the various embodiment of the present invention, automatically alarms the learner after the calculated waiting time to conduct reviews.

The method can also be implemented on a server that interacts with a learner through wireless transmissions over a mobile network or wired transmission over Internet. The learner can use his or her cellular handset, personal digital assistant (PDA), or desktop of notebook computer to conduct reviews on the server. On the other hand, the server keeps track the learning progress of the learner and reminds the learner to conduct reviews at appropriate times via cellular handset, PDA, or computer. Please note that the present invention can be implemented as a software program running on a computer, a PDA, an electronic dictionary, a cellular handset, or it can be implemented as part of the hardware of the computer, the PDA, the electronic dictionary, and the cellular handset.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A method of conducting reviews with optimal periodic cycle of a learning program, said learning program comprising a plurality of learning focuses, each of said learning focus being associated with at least a question, said method comprising the steps of:
a) defining a plurality of sequential memorization states and starting from a first memorization state;
b) conducting a review after a waiting time within each memorization state by using said questions to evaluate said learning focuses; and
c) continuing to a next memorization state if the review is success, otherwise returning to said step (b) after a waiting time adjustment process.

2. The method according to claim 1, wherein said waiting time adjustment process comprising the steps of:
(c1) calculating a success rate of answering said questions; and
(c2) if said success rate is above an upper bound, said waiting time is extended, if said success rate is below a lower bound, said waiting time is shortened, and otherwise said waiting time is not changed.

3. The method according to claim 1, wherein said waiting time adjustment process comprising the steps of:
(c1) calculating a success rate of answering said questions; and
(c2) if said success rate is above an upper bound, a second waiting time is determined by extending said waiting time, if said success rate is below a lower bound, said second waiting time is determined by shortening said waiting time, otherwise said second waiting time is set to said waiting time;
(c3) conducting a review after said second waiting time by using said questions to evaluate said learning focuses; and
(c4) continuing to the said step (b) if said review is success, otherwise calculating a success rate of answering said questions, if said success rate is above an upper bound, said second waiting time is extended, if said success rate is below a lower bound, said second waiting time is shortened, otherwise said second waiting time is unchanged.

4. The method according to claim 1, wherein said waiting time adjustment process comprising the steps of:
(c1) calculating a success rate of answering said questions; and
(c2) if said success rate is above an upper bound, a second waiting time is determined by extending said waiting time, if said success rate is below a lower bound, said second waiting time is determined by shortening said waiting time, otherwise said second waiting time is set to said waiting time;
(c3) conducting a review after said second waiting time by using said questions to evaluate said learning focuses; and
(c4) continuing to a next memorization state if said review is success, otherwise calculating a success rate of answering said questions, if said success rate is above an upper bound, said second waiting time is extended, if said success rate is below a lower bound, said second waiting time is shortened, otherwise said second waiting time is unchanged.

5. The method according to claim 1, wherein said method is implemented as software running on or part of the hardware of a computer, a PDA, an electronic dictionary, and a cellular handset.

6. The method according to claim 1, wherein said method is implemented as a set of printed, loosed-leaf tables and forms for recording memorization states and evaluation results.
